(19) United States
(12) Patent Application Publication
(10) Pub. No.: US 2016/0158776 A1
(43) Pub. Date: Jun. 9, 2016

(54) SPRAY BOTTLE WITH STORAGE AREA AND METHODS THEREOF

(71) Applicants: Eric Sternberg, Wantagh, NY (US); Mathew Sternberg, Seaford, NY (US)

(72) Inventors: Eric Sternberg, Wantagh, NY (US); Mathew Sternberg, Seaford, NY (US)

(21) Appl. No.: 14/563,436

(22) Filed: Dec. 8, 2014

(51) Int. Cl. B05B 11/00; B67C 3/02; B67B 6/00

(52) U.S. Cl. CPC B05B 11/0037; B05B 11/0097; B05B 11/30; B67B 6/00; B67C 3/02

(57) ABSTRACT

A spray bottle is provided that may comprise a spray head for spraying liquid contained within the spray bottle; a bottle for storing the liquid, the bottle comprising a bottle attachment; a compartment for storing items, the compartment comprising a storage attachment adapted to detachably attach to the bottle attachment. In some embodiments the spray bottle apparatus may comprise a spray head for spraying liquid contained within the spray bottle; a bottle for storing the liquid, the bottle comprising a bottle attachment; a compartment for storing items, the compartment comprising a storage attachment adapted to detachably attach to the bottle attachment; and wherein the bottle attachment and the storage attachment comprise inversely threaded portions adapted to couple with each other.

### BACKGROUND OF THE INVENTION

1. Field of the Invention

Embodiments of the present invention generally relate to a spray bottle having a storage area and methods thereof. More specifically, embodiments of the present invention relate to a spray bottle having a top reservoir and a bottom storage compartment for storing refill packets or the like.

2. Description of the Related Art

Spray bottles for spraying household and industrial liquid products are convenient for applying liquid products to desired surface areas. Most conventional spray bottles include a spray cap detachably mounted to the neck of a bottle with a dip tube or straw extending from the spray head into the body of the bottle. The fluid inside the bottle is pumped or drawn through the dip tube and out of the nozzle of spray head. Unfortunately, prior art spray bottles available commercially come filled with a fixed amount of liquid product and after the liquid product is depleted the bottles are typically discarded. As a result, many of these spray bottles are only used once, and must be replaced by additional bottles increasing the cost to the consumer and having a potential negative environmental impact caused by the discarded bottles.

Some solutions to this problem have included smaller bottles of concentrated “refill” solutions to be added to the spray bottle and diluted and mixed with water to produce the fixed amount of liquid product. These refills are packaged in their own bottles that require storage space in the consumer's home or the retailer's shelf space. These smaller bottles must also be discarded after the refill is used. As such, while the problems with spray bottles can be reduced by separate smaller bottles with refill solution, the costs of the refill bottles and the need to discard them make them an ineffective solution. There is no existing solution for storing refill material in an efficient matter that eliminates the need for secondary bottles that need to be discarded.

As such, there is a need for a spray bottle for storing refill material in an efficient matter that eliminates the need for secondary bottles that need to be discarded.

### SUMMARY

Embodiments of the present invention generally relate to a spray bottle that may comprise a spray head for spraying liquid contained within the spray bottle; a bottle for storing the liquid, the bottle comprising a bottle attachment; a compartment for storing items, the compartment comprising a storage attachment adapted to detachably attach to the bottle attachment.

In another embodiment of the present disclosure, a spray bottle apparatus may comprise a spray head for spraying liquid contained within the spray bottle; a bottle for storing the liquid, the bottle comprising a bottle attachment; a compartment for storing items, the compartment comprising a storage attachment adapted to detachably attach to the bottle attachment; and wherein the bottle attachment and the storage attachment comprise inversely threaded portions adapted to couple with each other.

In another embodiment of the present disclosure, a method for using a spray bottle may comprise providing a bottle apparatus comprising: a spray head for spraying liquid contained within the spray bottle; a bottle for storing the liquid, the bottle comprising a bottle attachment; a compartment for storing items, the compartment comprising a storage attachment adapted to detachably attach to the bottle attachment; wherein the bottle attachment and the storage attachment comprise inversely threaded portions adapted to couple with each other; and wherein the compartment comprises a compartment wall surrounding a storage area adapted to store refill packets. removing the compartment by unscrewing the compartment from the bottle; removing a refill packet; removing the spray head and inserting a refill packet within the bottle; filling the bottle with a liquid and allowing the refill packet to react to the liquid and release a concentrated substance, thereby diluting the concentrated substance in the liquid; replacing the spray head; and reattaching the compartment by screwing the compartment into the bottle.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a side view of a spray bottle in an open configuration in accordance with embodiments of the present disclosure;

FIG. 2 depicts a side view of a spray bottle in a closed configuration in accordance with embodiments of the present disclosure;

FIG. 3 depicts a plan view of an example article to be stored within a storage area in a spray bottle in accordance with embodiments of the present disclosure; and

FIG. 4 depicts a flowchart of a method of using a spray bottle in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a spray bottle having a storage area and methods thereof. More specifically, embodiments of the present invention relate to a spray bottle having a top reservoir and a bottom storage compartment for storing refill packets or the like.

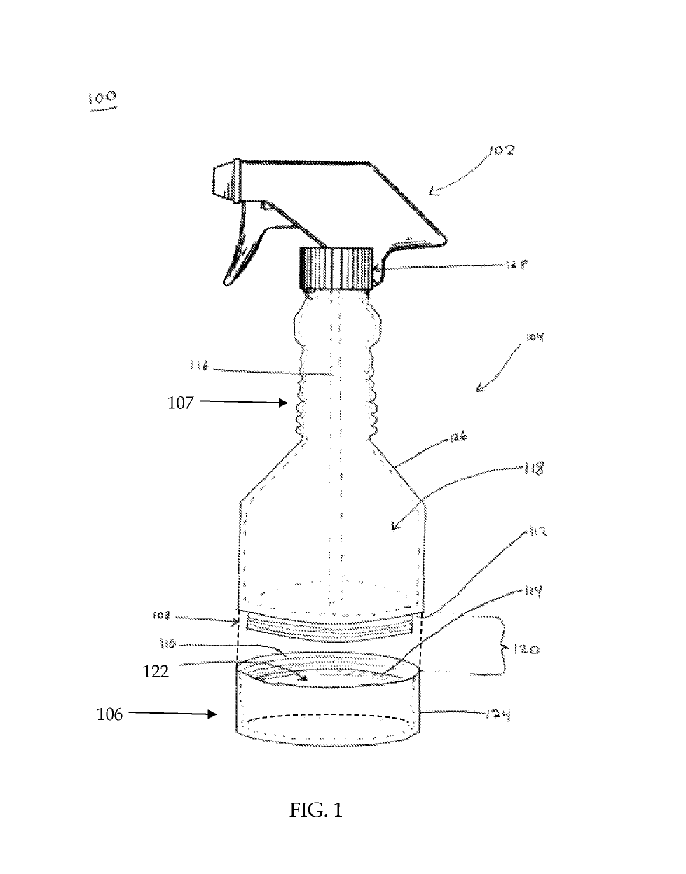

FIG. 1 depicts a side view of a spray bottle apparatus 100 in an open configuration in accordance with embodiments of the present disclosure. In accordance with exemplary embodiments, the bottle apparatus 100 may comprise a spray head 102, a bottle 104, a compartment 106, and/or the like. The bottle apparatus 100 may comprise a handle 107 generally formed in a diameter that allows a user to grip the handle 107 with relative ease. The handle 107 may be formed in an ergonomic shape, ore the like, to decrease the stress on the user's hand and wrist and to allow the user to easily maneuver the apparatus 100 when in use. The bottle apparatus 100 may comprise a narrow handle 107 and a wider base for storage of a composition and/or other items. The use of standard sized and shaped spray bottle configurations are contemplated by and within embodiments of the present invention. Alternative shapes and sizes, such as bottles with narrower bases and wider handles, or any other shape or size is contemplated by and within embodiments of the present invention. The spray bottle apparatus 100 may comprise a bottle 104 that can squirt, spray, or mist fluids.

The bottle apparatus 100 may comprise plastic, metal, glass, and/or any sturdy material that is adapted to hold a composition in accordance with embodiments of the present disclosure. A composition may comprise, for example, cleaning compositions, gardening compositions, pest control compositions, and/or the like. The storage capacity may generally comprise 4 ounces to 100 ounces of liquid, but smaller and larger capacity sizes are contemplated by and within embodiments of the present disclosure. For example the storage capacity of a spray bottle may comprise 12 ounces, 24 ounces, 60 ounces, and/or the like. The bottle may be translucent or it may be opaque. In some embodiments, the apparatus 100 may comprise indicia for measurement, advertising labels, messages, and/or the like.

Generally, the bottle apparatus 100 may be formed to store a liquid composition in the bottle 104 and other items, such as refill packets, in the compartment 106, or the like. By way of example, the container may comprise concentrated liquids in water-soluble packets for placing within the bottle 104 when the initial level of liquid composition is depleted. The concentrated liquids may comprise, for example, concentrated carpet cleaner, glass cleaner, disinfectant, weed killer, fertilizer, pest control liquid, and/or the like. In use, the user may use the bottle apparatus 100 until an initial amount of liquid stored in the bottle 104 is depleted. When the user desires to refill the bottle 104, the user will detach the compartment 106 from the bottle 104, remove a water-soluble refill packet containing concentrated liquid material, remove the spray head, place the refill packet in the bottle, add water to release the liquid material within the refill packet and dilute the liquid material to a useable or optimized level of concentration, replace the compartment 106 and the spray head 102, and resume use of the bottle apparatus 100 with a full bottle 104.

In exemplary embodiments, the spray head 102 may comprise a standard manual pump spray head. In some embodiments, the spray head 102 may be utilized by manual pumping, electric pumping, and/or the like. The spray head 102 may draw liquid up a tube 116, which may comprise a siphon tube, and force the liquid out of a nozzle. The spray head 102 may or may not be adjustable, as to select between squirting a stream, aerosolizing a mist, or dispensing a spray, and/or the like. In some embodiments, dispensing the liquid is generally powered by the user's efforts and/or by an electronic means such as a battery powered spray head, pump, and/or the like. The spray head 102 may comprise a spray attachment 128, such as a screw cap, or the like, adapted to connect the spray head 102 to the bottle 104.

In exemplary embodiments, a bottle 104 may generally comprise a handle 107, a bottle wall 126, a reservoir 118, an upper lip 112, a bottle attachment, and/or the like. A bottle wall 126 may be made out of material that is unreactive to the liquids stored within the bottle and may be sufficiently sturdy to resist breaking when dropped and/or resist being pierced. The reservoir 118 may be e adapted to hold a liquid and may generally follow the contour of the bottle wall 126. The reservoir 118 may comprise a storage space sufficient to hold a predetermined amount of liquid composition, for example, 24 ounces of liquid, or the like. The bottle 104 may comprise any shape that allows the bottle to have a bottle attachment 108 positioned at the bottom of the bottle 104.

In exemplary embodiments, the bottle attachment 108 may comprise a member formed to mate with and/or detachably attach to, a portion of the compartment 106. The bottle attachment 108 may mate with a storage attachment 110 of the compartment 106.

The bottle attachment 108 may be set in off an outer edge of the bottle such that the diameter of the bottle attachment 108 is less than the diameter or outside perimeter of the portion of the bottle 104 immediately above the bottle attachment 108 on a lower portion of the bottle 104. The bottle attachment 108 may be offset such from the lower outermost edge of the bottle 104 such that an upper lip 112 is formed adjacent the outer perimeter of a lower portion of the bottle 104. The upper lip 112 may attach at a perpendicular connection point to the attachment 108, or may connected at an angle. The upper lip 112 may generally comprise a flat surface extending from the an outer lowermost portion of the compartment wall 126 inwardly to the bottle attachment 108. The bottle attachment 108 may comprise a lower surface covering an entire area between the perimeter and/or circumference of the lowermost outer perimeter of the bottle attachment 108. The bottle attachment 108 may comprise a flat bottom or a substantially curved or angled portion, and/or the like. In some embodiments, a hollow portion may be disposed in an area between immediately above a surface covering the bottom of the bottle attachment 108 and immediately below a floor portion of the reservoir 118 and may be sealed by the floor portion of the reservoir and the surface covering the bottom of the bottle attachment 108. In some embodiments, the reservoir 118 may extend into the bottle attachment 108 to the surface covering the bottom of the bottle attachment 108, thereby creating more storage space by allowing more contents to be stored immediately above the surface covering the bottom of the bottle attachment 108 and under a horizontal plane running through the uppermost portion of the upper lip 112, and/or the like.

In one embodiment, the bottle attachment 108 may comprise screw threads that couple with the storage attachment 110, which may comprise inversely threaded threads. Treading may be disposed on an outer surface of the bottle attachment 108 and inverse threading that couples with the threading disposed on an outer surface of the bottle attachment 108 may be disposed on the storage attachment on an inner surface of the compartment 106. The bottle attachment 108 may also comprise one or more protrusions for snapping into and coupling with the storage attachment 110. The bottle 104 may generally be detachably attached to the compartment 106 by way of the bottle attachment 108 and the corresponding storage attachment 110. In some embodiments, the bottle 104 may be substantially rounded such that rotation of the bottle 104 may allow the bottle attachment 108 to screw into and/or attach to the storage attachment 110 wherein a connection area 120 is formed and the upper lip 112 meets an upper portion of the compartment 106. In some embodiments, the bottle 104 may comprise a protrusion allowing it to snap into the compartment 106 or vice versa. For example, the connection area may protrude outwardly and fit with a corresponding indentation in the compartment 106 creating a snap fit. The bottle 104 and the compartment 106 may also connect via alternative connection means, such as hook/loop fasteners, adhesive, friction fit, interference fit, press fit, snaps, clips, and/or the like. While a bottle 104 with a rounded reservoir 118 and compartment 106 is generally depicted in the figures, other shapes are contemplated by and within embodiments of the present disclosure. For example the reservoir 118 and/or compartment 106 may comprise a cross-section or outer surface generally comprising a circle, oval, parallelogram, square, rectangle, pentagon, hexagon, octagon shape, and/or the like.

In exemplary embodiments, the compartment 106 may be adapted to store items and may be adapted to mate with the bottle 104. The compartment 106 may comprise a compartment wall 124, a storage area 122, a storage attachment 110, a lower lip 114, and/or the like. The compartment 106 may be of any size and/or shape adapted to hold items such as water soluble refill packets, and/or the like. The compartment 106 may be rounded such that rotation of the compartment 106 while aligning the storage attachment 110 with the bottle attachment 108 would allow the storage attachment 110 to mate with the bottle attachment 108 via corresponding threading, whereby the bottle 104 and the compartment 106 are detachably attached at a connection area 120. The bottle attachment 108 may comprise screw threads and the storage attachment 110 may comprise screw threads formed to couple with the threads disposed on the bottle attachment 108, thereby allowing the bottle attachment 108 to couple with and/or screw into the storage attachment 110. A compartment wall 126 may be made out of material that is unreactive to the items stored within the compartment 106 and may be sufficiently sturdy to resist breaking when dropped and/or resist being pierced. The storage area 122 may be e adapted to hold items such as water soluble refill packets and may generally follow the contour of the compartment wall 124. The storage area 122 may comprise a storage space sufficient to hold a predetermined amount items, for example 4-8 refill packets, and/or the like. The compartment 106 may comprise any shape that allows the compartment 106 to have a compartment attachment 110 positioned at the top of the compartment 106. The compartment 106 may generally comprise an area for storage and may be adapted to couple with and/or detachably attach to a bottle 104, so that when the bottle 104 runs out of liquid, a refill is readily available in the compartment 106, and/or the like.

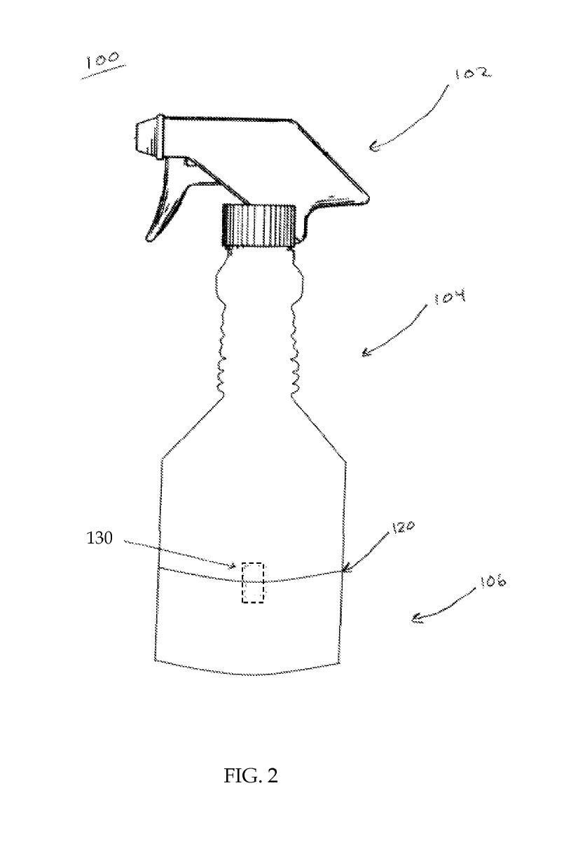

Referring now to FIG. 2, a side view of a spray bottle apparatus 100 in a closed configuration in accordance with embodiments of the present disclosure is depicted. When the apparatus 100 is in the connected position and the bottle 104 is connected to the compartment 106 at the connection area 120, a substantially continuous flat wall along a side of the apparatus 100. In some embodiments, a securing member 130 may be provided to secure the bottle 104 to the compartment 106 so that the compartment 106 may resist dislodging from the bottle 104 when the securing member 130 is engaged. In some embodiments, the securing member 130 may comprise a clip, a lock, an adhesive member, and/or the like that may be adapted to keep the bottle 104 attached to the compartment 106.

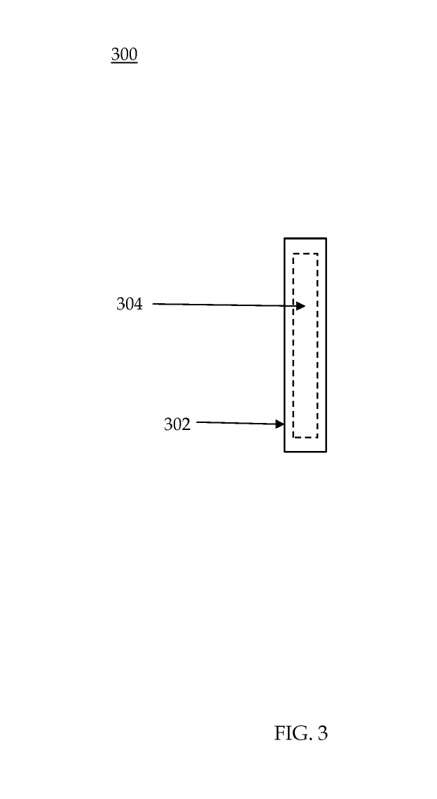

Referring now to FIG. 3, a plan view of an example article 300 to be stored within a storage area in a spray bottle in accordance with embodiments of the present disclosure is depicted. In some embodiments, the article 300 to be stored may comprise a water soluble refill packet containing a concentrated substance for use with a bottle in accordance with embodiments of the present disclosure. In some embodiments, the article 300 may comprise a refill wall 302 and a refill space 304. The refill wall 302 may generally comprise a water soluble material and may be adapted to hold a concentrated liquid in the refill space 304 in accordance with the present invention. The article 300 may be dropped into the bottle and combined with water to release concentrated liquid and dilute the concentrated liquid inside the interior of the bottle.

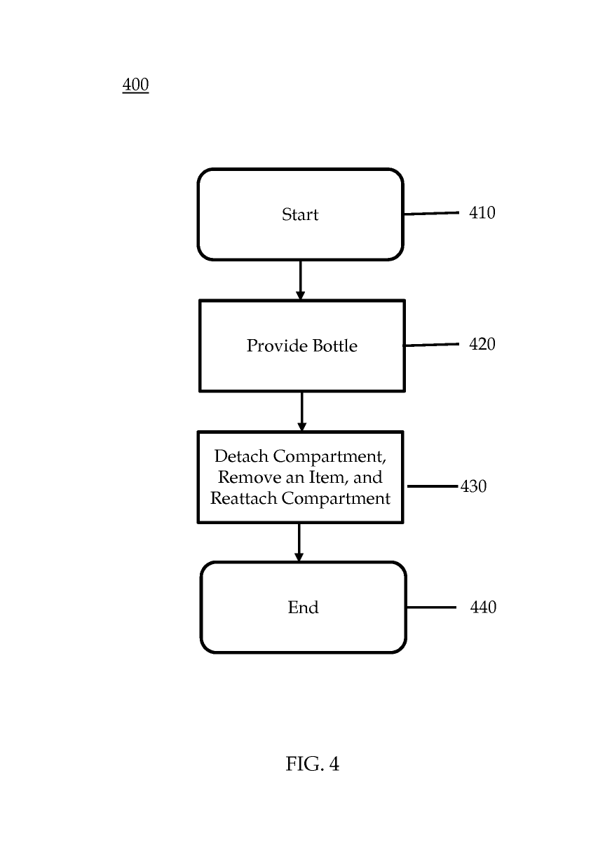

Referring now to FIG. 4, a flowchart of a method 400 of using a spray bottle in accordance with embodiments of the present disclosure is depicted. The method begins at step 410. For ease, the method 400 is described herein with reference to the spray bottle 100 examples illustrated in FIGS. 1-3. At step 420, a spray bottle 102 is provided. In exemplary embodiments, the securing spray bottle 102 may comprise a spray head 102, a bottle 104, a compartment 106, and/or the like. When the spray bottle runs out of liquid, the user may detach the compartment 106 at step 430. The user may then remove a refill packet from the compartment 106 and place it into the bottle 104 for dilution. The compartment 106 may then be reattached to the bottle 104. In some embodiments, a securing member 130 may be engaged to prevent the compartment 106 from detaching from the bottle 104. After step 430, the bottle 104 may be used again with refilled composition and the method ends at step 440.

While the foregoing is directed to embodiments of the present invention, other and further embodiments of the invention may be devised without departing from the basic scope thereof. For example, although numerous embodiments having various features have been described herein, combinations of such various features in other combinations not discussed herein are contemplated within the scope of embodiments of the present invention.

What is claimed is:

1. A spray bottle apparatus comprising:
a spray head for spraying liquid contained within the spray bottle;
a bottle for storing the liquid, the bottle comprising a bottle attachment;
a compartment for storing items, the compartment comprising a storage attachment adapted to detachably attach to the bottle attachment.

2. The spray bottle apparatus of claim 1, wherein the bottle comprises a handle and a wider base.

3. The spray bottle apparatus of claim 1, wherein the bottle attachment and the storage attachment comprise screw threads that are inversely threaded and formed to couple with each other.

4. The spray bottle apparatus of claim 1, wherein the bottle is adapted to snap to the compartment and detachably attach to the compartment.

5. The spray bottle apparatus of claim 1, wherein the bottle comprises at least one of plastic, metal, and glass.

6. The spray bottle apparatus of claim 1, wherein the compartment comprises a compartment wall surrounding a storage area adapted to store items.

7. The spray bottle apparatus of claim 6, wherein the items comprise at least one of a concentrated cleaning composition, a concentrated gardening composition, and a concentrated pest control composition.

8. The spray bottle apparatus of claim 1, wherein the bottle comprises a bottle wall surrounding a reservoir for holding a liquid composition.

9. The spray bottle apparatus of claim 8, wherein the liquid composition comprises at least one of a cleaning composition, a gardening composition, and a pest control composition.

10. A spray bottle apparatus comprising:
a spray head for spraying liquid contained within the spray bottle;
a bottle for storing the liquid, the bottle comprising a bottle attachment;
a compartment for storing items, the compartment comprising a storage attachment adapted to detachably attach to the bottle attachment;
wherein the bottle attachment and the storage attachment comprise inversely threaded portions adapted to couple with each other.

11. The spray bottle apparatus of claim 10, wherein the bottle comprises at least one of plastic, metal, and glass.

12. The spray bottle apparatus of claim 10, wherein the compartment comprises a compartment wall surrounding a storage area adapted to store items.

13. The spray bottle apparatus of claim 12, wherein the items comprise at least one of a concentrated cleaning composition, a concentrated gardening composition, and a concentrated pest control composition.

14. The spray bottle apparatus of claim 10, wherein the bottle comprises a bottle wall surrounding a reservoir for holding a liquid composition.

15. The spray bottle apparatus of claim 14, wherein the liquid composition comprises at least one of a cleaning composition, a gardening composition, and a pest control composition.

16. A method for refilling a spray bottle, the method comprising:
providing a bottle apparatus comprising:
a spray head for spraying liquid contained within the spray bottle;
a bottle for storing the liquid, the bottle comprising a bottle attachment;
a compartment for storing items, the compartment comprising a storage attachment adapted to detachably attach to the bottle attachment;
wherein the bottle attachment and the storage attachment comprise inversely threaded portions adapted to couple with each other; and
wherein the compartment comprises a compartment wall surrounding a storage area adapted to store refill packets;
removing the compartment by unscrewing the compartment from the bottle;
removing a refill packet;
removing the spray head and inserting a refill packet within the bottle;
filling the bottle with a liquid and allowing the refill packet to react to the liquid and release a concentrated substance, thereby diluting the concentrated substance in the liquid;
replacing the spray head; and
reattaching the compartment by screwing the compartment into the bottle.

17. The method of claim 16, wherein the bottle comprises a narrow handle and a wider base.

18. The method of claim 16, wherein the bottle comprises at least one of plastic, metal, and glass.

19. The method of claim 16, wherein the compartment comprises a compartment wall surrounding a storage area adapted to store items.

20. The method of claim 16, wherein the bottle comprises a bottle wall surrounding a reservoir for holding a liquid composition.
